(19) United States
(12) Patent Application Publication
(10) Pub. No.: US 2012/0185780 A1
(43) Pub. Date: Jul. 19, 2012

(54) SYSTEM AND METHOD FOR INTEGRATING MENU OPTIONS OF MESSAGE APPLICATIONS OF ELECTRONIC DEVICE

(75) Inventor: CEN MA, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/155,318

(22) Filed: Jun. 7, 2011

(30) Foreign Application Priority Data
Jan. 18, 2011 (CN) 201110020344.5

(51) Int. Cl. G06F 3/048

(52) U.S. Cl. 715/752

(57) ABSTRACT

In a method for integrating menu options of message applications of an electronic device, a user interface (UI) that includes an icon displaying area and an option displaying area are created. An icon is created for each of the message applications, and all of the created icons are placed into the icon displaying area. The UI is displayed on a display screen of the electronic device when the UI is activated, and operating options of a message application are displayed in the option displaying area when one of the created icons corresponding to the message application is selected.

### BACKGROUND

1. Technical Field

Embodiments of the present disclosure relate generally menu options of electronic devices, and more particularly, to a system and method for integrating menu options of an electronic device.

2. Description of Related Art

Many applications are installed in electronic devices to provide different functions. Generally, each application has a function icon included in a main menu of an electronic device. The icons of the main menu will become more numerous, even too numerous, as electronic devices become more functional, which may cause inconvenience for users. In addition, the electronic devices have some similar message applications that are provided to the users to edit, store, receive, and send messages. The message applications may include a short message service (SMS) application, an e-mail application, a notepad application, and a template application. Therefore, it is necessary to integrate menu options of the message applications to decrease the number of icons of the main menu.

### BRIEF DESCRIPTION OF THE DRAWINGS

FIG. 1 is a block diagram of one embodiment of an electronic device including an integration system.

FIGS. 2A and 2B are schematic diagrams of one embodiment of user interfaces of the electronic device.

FIG. 3 is a flowchart of one embodiment of a method for integrating menu options of message applications of the electronic device of FIG. 1.

FIG. 4 is a flowchart of an example sending a message stored in the electronic device using a SMS application or an e-mail application of the message applications.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

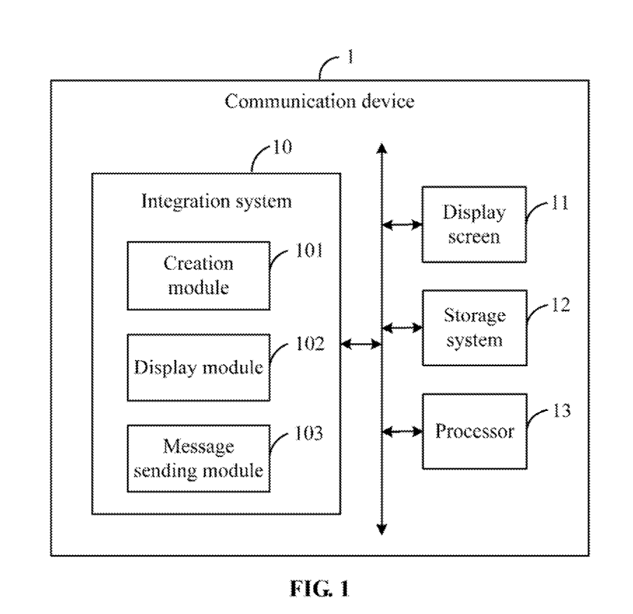

FIG. 1 is a block diagram of one embodiment of an electronic device 1 including an integration system 10. In the embodiment, the device 1 further includes a display screen 11, a storage system 12, and a processor 13. The device 1 may be a mobile phone, a personal digital assistant (PDA), or other portable device. It should be apparent that FIG. 1 illustrates only one example of the device 1, and the device 1 can include more or fewer components in other embodiments, or have a different configuration of the various components.

The storage system 12 stores one or more programs, such as programs of an operating system, and other applications of the device 1. In one embodiment, the storage system 12 may be a random access memory (RAM) for temporary storage of information, and/or a read only memory (ROM) for permanent storage of information. In other embodiments, the storage system 12 may also be an external storage device, such as a hard disk, a storage card, or other data storage medium. The processor 13 executes computerized operations of the device 1 and other applications to provide functions of the device 1.

The integration system 10 may include a plurality of functional modules comprising one or more computerized instructions that are stored in the storage system 12 or a computer-readable medium of the device 1, and executed by the processor 13 to perform operations of the device 1. In the embodiment, the integration system 10 includes a creation module 101, a display module 102, and a message sending module 103. In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of computer-readable medium or other storage device.

In the embodiment, the integration system 10 is executed to integrate menu options of message applications of the device 1. The message applications may include, for example, a short message service (SMS) application, an e-mail application, a notepad application, and a template application that are provided to a user to edit, store, receive, and send messages. In other embodiment, the message applications may include other applications of the electronic device 1.

The creation module 101 is operable to create a user interface (UI) that includes an icon displaying area and an option displaying area, create an icon for each of the message applications, and place all of the created icons into the icon displaying area. Each of the created icons may be selected by the user to execute a corresponding function of one of the message applications. The created UI may be displayed on the display screen 11 when a user operates the device 1 to activate the UI.

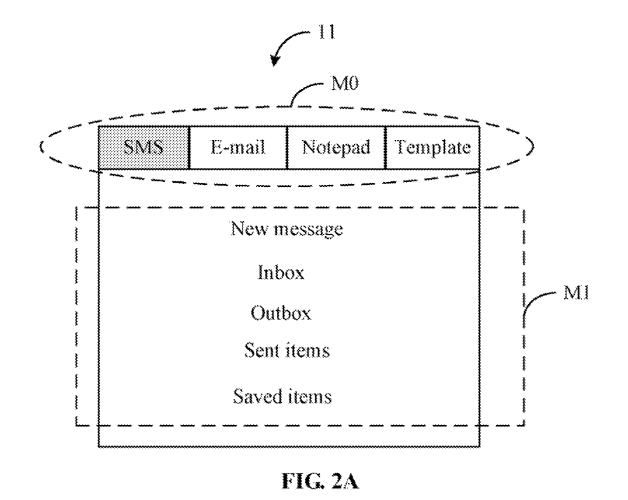

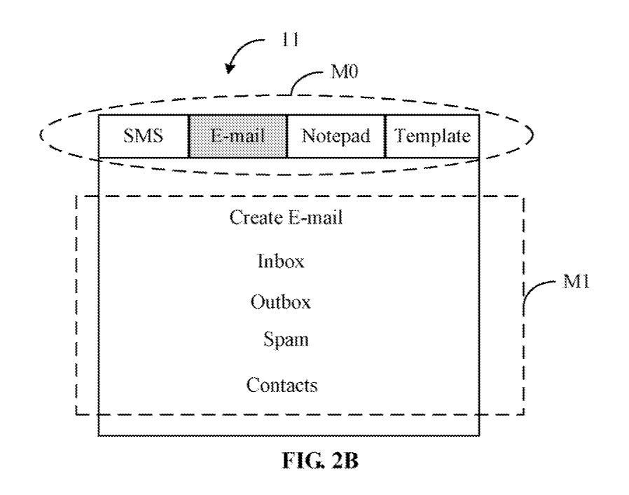

In the embodiment, the UI is provided for the user to use functions of the message applications. In one example, as shown in FIG. 2A, an icon displaying area M0 and an option displaying area M1 is created in the UI. The area M0 includes, for example, an “SMS” icon, an “E-mail” icon, a “Notepad” icon, and a “Template” icon for the corresponding applications. The area M1 includes a plurality of operating options, which may be icons, texts, or other UI elements, that when selected, execute a corresponding function of the device 1. In other embodiments, the device 1 may include more user interfaces. In addition, the creation module 101 is further operable to create a function icon that can be operated by the user to activate the created UI, and place the function icon in a main menu of the device 1. This way, the message applications share one icon in the main menu, so that the main menu is not cluttered with so many icons.

The display module 102 is operable to display the created UI on the display screen 11 when the UI is activated by the user, and display operating options of a message application in the option displaying area when one of the created icons corresponding to the message application is selected, to integrate the operating options of the message applications into the option displaying area. The user may activate the UI by selecting the created function icon in the main menu. In one embodiment, referring to FIG. 2A, the display module 102 displays operating options of the SMS application, such as, “New message”, “Inbox”, “Outbox”, “Sent items”, and “Saved Items”, in the option displaying area M1, when the user selects the “SMS” icon. Referring to FIG. 2B, the display module 102 displays operating options of the e-mail application, such as, “Create E-mail”, “Inbox”, “Outbox”, “Spam”, and “Contacts”, in the option displaying area M1, when the user selects the “E-mail” icon. Similarly, the display module 102 will display operating options of the notepad application or the template application in the option displaying area M1, when either of their icons is selected.

The message sending module 103 is operable to manage a process for sending a message stored in the device 1. Details are as follows. In one embodiment, messages stored in the device 1 may be sent according to user requirements using the SMS application or the e-mail application.

The message sending module 103 activates a message input user interface when a message stored in the device 1 is selected to be sent by the user, and inserts contents of the selected message into the message input user interface to create a new message. The message sending module 103 further sends the created message using the SMS application or the e-mail application according to decision of the user when the user finishes inputting messages in the message input user interface. In one embodiment, the selected message may be a short message, an e-mail, a text, or a template message stored in the device 1. The text may be created and stored using the notepad application. The template message may be created and stored using the template application.

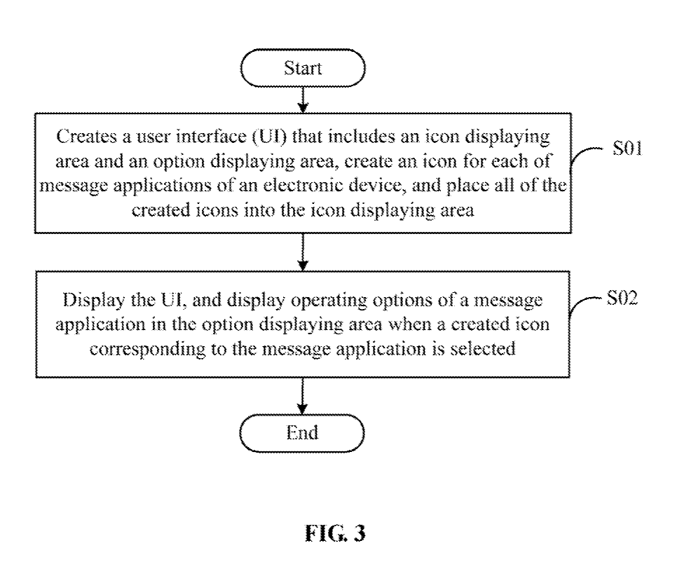

FIG. 3 is a flowchart of one embodiment of a method for integrating menu options of message applications of the electronic device of FIG. 1. Depending on the embodiment, additional blocks may be added, others removed, and the ordering of the blocks may be changed.

In block S01, the creation module 101 creates a user interface (UI) that includes an icon displaying area and an option displaying area for the device 1, creates an icon for each of the message applications, and places all of the created icons into the icon displaying area. Each of the created icons may be selected by the user to execute a corresponding function of one of the message applications. In addition, the creation module 101 further creates a function icon that can be operated by the user to activate the UI, and place the function icon in a main menu of the device 1. This way, the message applications share one icon in the main menu, so that the main menu is not cluttered with so many icons.

In block S02, the display module 102 displays the UI on the display screen 11 when the UI is activated by a user, and displays operating options of a message application in the option displaying area when one of the created icons corresponding to the message application is selected, to integrate operating options of the message applications into the option displaying area. The operating options may be icons, texts, or other UI elements, that when selected execute a corresponding function of the device 1. The UI may be activated when the created function icon in the main menu is operated by the user.

In one embodiment, the display module 102 displays operating options of the SMS application in the option displaying area when the “SMS” icon is selected, displays operating options of the e-mail application in the option displaying area when the “E-mail” icon is selected, displays operating options of the notepad application in the option displaying area when the “Notepad” icon is selected, or displays operating options of the template application in the option displaying area when the “Template” icon is selected.

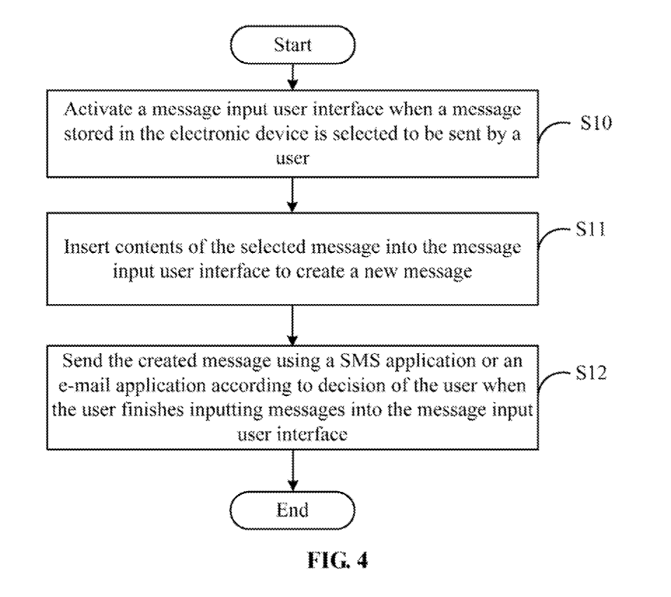

FIG. 4 is a flowchart of an example of sending a message stored in the electronic device using the SMS application or the e-mail application of the message applications.

In block S10, the message sending module 103 activates a message input user interface for inputting messages when a message stored in the device 1 is selected to be sent by the user. In one embodiment, the selected message maybe a short message, an E-mail, a text, or a template message stored in the device 1. The text may be created and stored using the notepad application. The template message may be created and stored using the template application.

In block S11, the message sending module 103 inserts contents of the selected message into the message input user interface to create a new message. When the contents of the selected message are inserted into the message input user interface, the user may input other messages into the message input user interface according to requirements.

In block S12, the message sending module 103 sends the created message using the SMS application or the e-mail application according to decision of the user when the user finishes inputting messages into the message input user interface.

This invention can be used for any similar applications of electronic devices, but in this disclosure, message applications are described as an example. Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for integrating menu options of message applications of an electronic device, the method comprising:
creating a user interface (UI) for the electronic device, the UI comprising an icon displaying area and an option displaying area;
creating an icon for each of the message applications, and placing all of the created icons into the icon displaying area;
displaying the UI on a display screen of the electronic device when the UI is activated; and
displaying operating options of a message application in the option displaying area when one of the created icons corresponding to the message application is selected, to integrate operating options of the message applications into the option displaying area.

2. The method according to claim 1, further comprising:
creating a function icon for activating the UI, and place the function icon in a main menu of the electronic device.

3. The method according to claim 1, wherein the message applications comprise a short message service (SMS) application, an e-mail application, a notepad application, and a template application.

4. The method according to claim 3, wherein the step of displaying operating options comprises:
displaying operating options of the SMS application in the option displaying area, when an icon of the SMS application is selected;
displaying operating options of the e-mail application in the option displaying area, when an icon of the e-mail application is selected;
displaying operating options of the notepad application in the option displaying area, when an icon of the notepad application is selected; or displaying operating options of the template application in the option displaying area, when an icon of the template application is selected.

5. The method according to claim 3, further comprising:
activating a message input user interface when a message stored in the electronic device is selected to be sent by a user;
inserting contents of the selected message into the message input user interface to create a new message; and
sending the created message using the SMS application or the e-mail application according to decision of the user when the user finishes inputting messages into the message input user interface.

6. An electronic device, comprising:
a display screen;
at least one processor;
a storage system; and
one or more programs stored in the storage system and being executable by the at least one processor, the one or more programs comprising:
a creation module operable to create a user interface (UI) that comprises an icon displaying area and an option displaying area for the electronic device, create an icon for each of the message applications, and place all of the created icons into the icon displaying area; and
a display module operable to display the UI on the display screen when the UI is activated, and display operating options of a message application in the option displaying area when one of the created icons corresponding to the message application is selected, to integrate operating options of the message applications into the option displaying area.

7. The electronic device according to claim 6, wherein the creation module further operable to create a function icon for activating the UI, and place the function icon in a main menu of the electronic device.

8. The electronic device according to claim 6, wherein the message applications comprise a short message service (SMS) application, an e-mail application, a notepad application, and a template application.

9. The electronic device according to claim 8, wherein the operating options are displayed by:
displaying operating options of the SMS application in the option displaying area, when an icon of the SMS application is selected;
displaying operating options of the e-mail application in the option displaying area, when an icon of the e-mail application is selected;
displaying operating options of the notepad application in the option displaying area, when an icon of the notepad application is selected; or
displaying operating options of the template application in the option displaying area, when an icon of the template application is selected.

10. The electronic device according to claim 6, wherein the one or more programs further comprises:
a message sending module operable to activate a message input user interface when a message stored in the electronic device is selected to be sent by a user, insert contents of the selected message into the message input user interface to create a new message, and send the created message using the SMS application or the e-mail application according to decision of the user when the user finishes inputting messages into the message input user interface.

11. A non-transitory storage medium storing a set of instructions, the set of instructions capable of being executed by a processor of an electronic device, to perform a method for integrating menu options of message applications of the electronic device, the method comprising:
creating a user interface (UI) for the electronic device, the UI comprising an icon displaying area and an option displaying area;
creating an icon for each of the message applications, and placing all of the created icons into the icon displaying area;
displaying the UI on a display screen of the electronic device when the UI is activated; and
displaying operating options of a message application in the option displaying area when one of the created icons corresponding to the message application is selected, to integrate operating options of the message applications into the option displaying area.

12. The storage medium as claimed in claim 11, wherein the method further comprises:
creating a function icon for activating the UI, and place the function icon in a main menu of the electronic device.

13. The storage medium as claimed in claim 11, wherein the message applications comprise a short message service (SMS) application, an e-mail application, a notepad application, and a template application.

14. The storage medium as claimed in claim 13, wherein the step of displaying operating options comprises:
displaying operating options of the SMS application in the option displaying area, when an icon of the SMS application is selected;
displaying operating options of the e-mail application in the option displaying area, when an icon of the e-mail application is selected;
displaying operating options of the notepad application in the option displaying area, when an icon of the notepad application is selected; or
displaying operating options of the template application in the option displaying area, when an icon of the template application is selected.

15. The storage medium as claimed in claim 11, wherein the method further comprises:
activating a message input user interface when a message stored in the electronic device is selected to be sent by a user;
inserting contents of the selected message into the message input user interface to create a new message; and
sending the created message using the SMS application or the e-mail application according to decision of the user when the user finishes inputting messages into the message input user interface.
